(19) United States
(12) Patent Application Publication
(10) Pub. No.: US 2017/0023234 A1
(43) Pub. Date: Jan. 26, 2017

(54) Apparatus for Attaching Illuminators to Hand held Devices

(71) Applicants: Derek Dwayne Gary, Memphis, TN (US); Derrick Wilfred Charbonnet, Ocean Springs, MS (US)

(72) Inventors: Derek Dwayne Gary, Memphis, TN (US); Derrick Wilfred Charbonnet, Ocean Springs, MS (US)

(21) Appl. No.: 15/147,036

(22) Filed: May 5, 2016

Related U.S. Application Data
(60) Provisional application No. 62/166,892, filed on May 27, 2015.

(51) Int. Cl. F21V 33/00; F41G 1/35; F21L 4/00

(52) U.S. Cl. CPC F21V 33/0084; F21L 4/005; F41G 1/35; F21V 23/0414

(57) ABSTRACT

This invention is very simple, place the light on a small stem protruding between two fingers. In the case of a revolver, the grip would extend between the trigger finger and middle finger (or the middle finger and ring finger, or possibly between the ring finger and little finger). It would extend far enough so that a light mounted at the end would could clearly illuminate the target. The stem could be small and flat enough that there would be no discomfort. The same could be done with the grip of a knife or club.

### BRIEF SUMMARY

This invention is very simple, place the light on a small stem protruding between two fingers. In the case of a revolver, the grip would extend between the trigger finger and middle finger (or the middle finger and ring finger, or possibly between the ring finger and little finger). It would extend far enough so that a light mounted at the end would could clearly illuminate the target. The stem could be small and flat enough that there would be no discomfort. The same could be done with the grip of a knife or club.

### BRIEF DESCRIPTION OF THE ILLUSTRATIONS

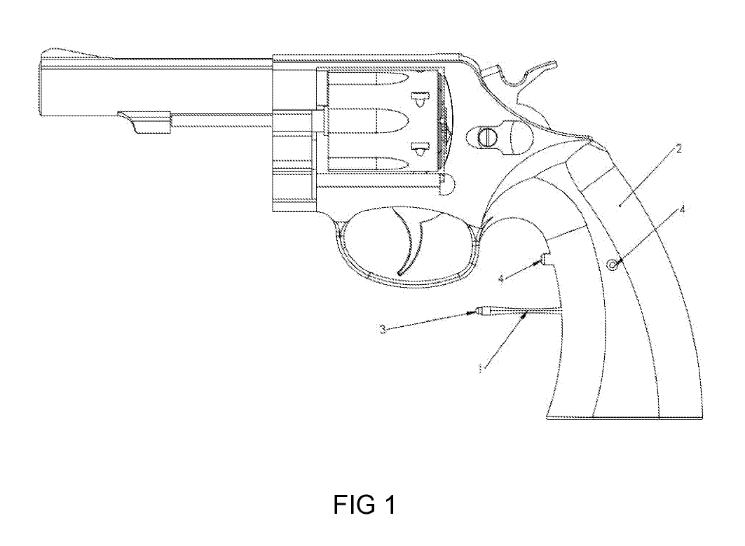

FIG. 1 shows a side view of a typical revolver. The stem (1) described in this patent can be clearly seen protruding forward from the grip.

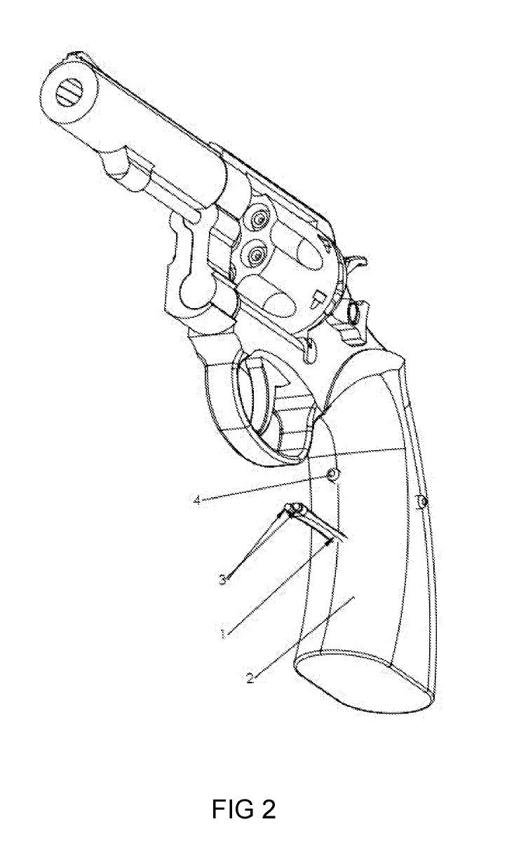

FIG. 2 is an oblique view of a typical revolver included for clarity. The stem (1) can be clearly seen.

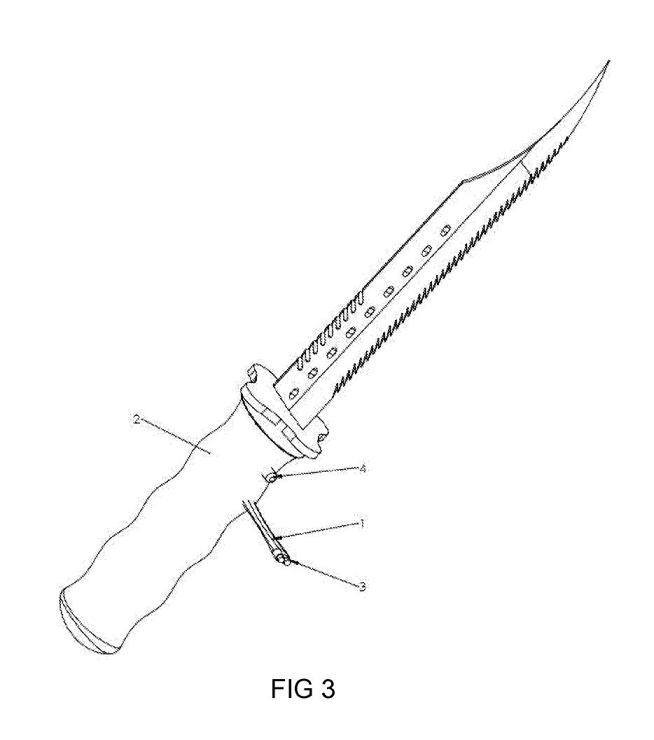

FIG. 3 shows the stem (1) described herein installed on a “survival knife.”

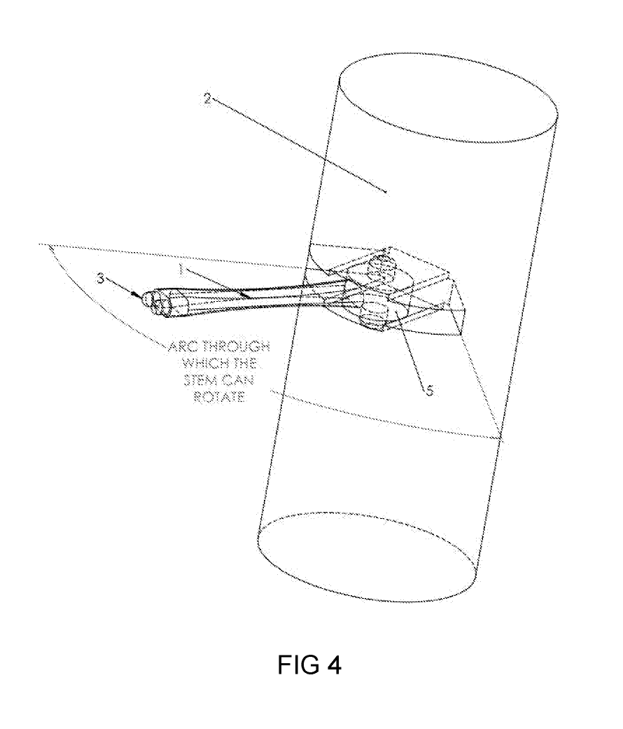

FIG. 4 shows a generic grip (2) and one embodiment of a rotating mechanism (5) in a slot in the grip. The rotating mechanism and the slot allow the stem to rotate between the fingers.

### DETAILED DESCRIPTION

This invention provides a way to shine illumination with the same hand that holds a tool or weapon. This invention is important for weapons or tools where the well understood ways to attach a light are not practical.

In various ways of attaching illumination to a weapon that are well understood in the art, the illuminator is attached alongside or under the barrel. There are many, many variations of this. However, on tools or weapons such a revolver, where the body and grip of the weapon is compact, there is simply no room.

A small stem (1) extending, more or less perpendicular from the grip (2) in the direction of the front of the weapon, or wherever illumination is required would hold the illuminator (3) (LED or bulb) {in the Figures, the stem is shown for convenience with two illuminators, there can be one or many}. The power would be supplied by batteries (or other power source), enclosed in the grip in the preferred embodiment. The illuminator would be activated by a plurality of switches (4) on the grip or weapon. The power to the illuminator(s) could be provided through in a hollow tube inside the stem in one embodiment.

The illuminator could be a single light or a plurality of lights. The different lights could be different colors.

Of particular interest for firearms would have one of these plurality of illuminators as a laser. The laser would be aimed in the same direction at the barrel to assist in the aiming of the weapon. Laser sights are well understood in the art, but this method of mounting them is new.

The illuminator could be switched on/off or its intensity changed by a plurality of switches or knobs on the grip. A convenient embodiment would have one switch built into the grip under one of the fingers. This would allow the user to turn the light on and off simply squeezing a finger.

We claim:

1. An apparatus (henceforth called a stem) (1) to hold an illuminating device (3) on the grip (2) of a tool or weapon.
(a) The stem would consist of a of an extrusion out of the grip and passing between two fingers of the person gripping the tool or weapon.
(b) The stem would hold, at or near the end away from the grip and clear of the fingers, a plurality of illuminating (3) devices {in the Figures, the stem is shown for convenience with two illuminators, there can be one or many}.

2. The stem in claim 1 can be pointed in various directions
(a) in the same direction as the front of the tool to provide illumination for it's use or searching or signaling
(b) In another direction relative to the front of the tool.

3. The stem in claim 1 could be mounted on an apparatus (5) that allows it to rotate in the same plane as the gap between the fingers allowing the user to point it in a direction of his choosing or control. This is shown in one generic embodiment in FIG. 4.

4. A plurality of stems (1) could be mounted on one grip (2).

5. The stem in claim 1 could be flexible allowing the user to point the end of the stem in any direction he wished.

6. The stem in claim 1 could have a plurality of embodiments to allow the power to reach the illuminators.
(a) One embodiment would be for the stem to be hollow running lengthwise from the grip to the illuminator. This embodiment would allow the wires providing the power to the illuminators to be placed in the hollow.
(b) A second embodiment would have have wires providing the power to the illuminators molded into the stem.
(c) A third embodiment would have the wires traveling on the outside of the stem.

7. The illuminating devices in claim 1 could be a plurality of types such as incandescent, light emitting diode, or other.

8. The illuminating devices in claim 1 could have a plurality of beam widths and shapes
(a) The spread of the light emitting from the illuminating device could be as narrow as a laser (coherent light) or as wide as possible given the stem and the users hand.

9. The illuminating devices in claim 1 could be a plurality of light frequencies
(a) the emitted light could be any wavelength or multiple wavelengths on the electromagnetic spectrum

10. The illuminating device in claim 1 could be mounted on the stem in claim 1 in a plurality of ways
(a) the illuminating device could be mounted in a fixed manner
(b) the illuminating device could be mounted in a way that the center-point of its beam could be adjusted by the user relative to the stem.
(c) The beam could rotate, swing, or move other directions automatically or by the user

11. The illuminators could be activated by a plurality of switches (4).
(a) the switches could be activated physically or electronically
(b) the switches could be mounted in a plurality of places on the grip
(c) the switches could be mounted so that they could be activated by the user by squeezing a finger against the switch.

12. The gain of the illumination could be adjusted by a plurality of knobs, sliders, or other controllers
(a) the controllers could be activated physically or electronically
(b) the controllers could be mounted in a plurality of places on the grip
(c) the controllers could be mounted so that they could be activated by the user by squeezing a finger against the switch.

13. The power supply for the illuminator would be contained in the grip or elsewhere in or on the tool or weapon.
